(19) United States
(12) Patent Application Publication
(10) Pub. No.: US 2022/0142127 A1
(43) Pub. Date: May 12, 2022

(54) Apparatus for Raising and Maintaining Oysters, Mollusks and Other Aquatic Life

(71) Applicant: Michael N. Schermeyer, Westhampton Beach, NY (US)

(72) Inventor: Michael N. Schermeyer, Westhampton Beach, NY (US)

(21) Appl. No.: 17/091,873

(22) Filed: Nov. 6, 2020

(51) Int. Cl. A01K 61/55; A01K 61/60

(52) U.S. Cl. CPC A01K 61/55; A01K 61/60

(57) ABSTRACT

An apparatus for containing, maintaining and raising oysters, mollusks and other aquatic life, the apparatus being formed of wood of sufficient buoyancy so that the structure will float on or in the surface of a body of water without additional buoyant elements. The apparatus has opening on each of two opposite sides and slats covering the top and the bottom of the box, the size of the holes and the spacing between the slats having dimensions such that the nutrient containing water body within which the structure has been deployed, may freely flow through the box while containing and maintaining the selected aquatic life within the apparatus. The device may also contain baffles within the interior space to keep the containing and growing aquatic life form shifting in the device as nutrient rich water passes therethrough.

### FIELD OF THE INVENTION

This invention is directed to an apparatus for maintaining and containing of oysters, mollusks, and other aquatic life on and in a body of water within a marine environment.

The invention pertains to the natural propagation and growth of such aquatic life within and on a marine environment such that aquatic life is maintained within an apparatus that will contain such life as it grows while at the same time allowing the aquatic life to feed on and be sustained by the nutrients typically found in the water in such marine environment.

The invention further pertains to the field of aquaculture which permits such aquatic life to grow and propagate within such marine environment in an open bay or other appropriate area.

### BACKGROUND OF THE INVENTION

It is quite common for aquatic life such as oysters, clams, other mollusks and shellfish as well as bait fish and even eels to be contained, maintained and grown within or on the body of water where they are usually found. This is typically accomplished utilizing baskets, cages, trays, racks, or the like. These containers hold the contained aquatic life in a fixed location relative to the surface or bottom of the water body, most typically, at least in the case of oysters, just at or just below the surface of the water body. This arrangement allows the nutrient rich water to “flow through” the container so that the aquatic life contained therein can feed and grow within the contained environment.

The devices for maintaining and containing of oysters, mollusks and other aquatic life on and in a body of water within a marine environment shown in the prior art, are typically made of plastic and as such are a very poor material choice in an environmentally conscious world. In addition, the plastic degrades over time due to repeated exposure to sunlight, thereby reducing the useful life of the devices and adding to the polluting aspect of same.

The devices of the prior art, also, typically require the use of buoyancy enhancing elements for them to float. These buoyancy enhancing elements are also typically made from plastic and often float the apparatus too high in the body of water to properly grow the contained aquatic life.

In addition, due to the nature of the plastic construction of the prior art devices, it is difficult to form a hatch or large operable opening therein so that it is difficult to deliver the aquatic life into and out of same and cleaning of the device is also labor intensive, often requiring the removal of the device from the water environment in its entirety to properly clean same or harvest the aquatic life maintained within. The plastic cages are most often secured with one time use plastic ties that must be replaced every time a cage is opened.

Furthermore, the devices known in the prior art lack a mechanism to prevent the aquatic life contained therein from moving within the device such that it all collects at one side or the other of the device depending on the direction of flow of water through the device. This uneven distribution of the aquatic life within the device may affect the growth of the aquatic life in that it affects the proper, level flotation of the device.

Finally, the device of the prior art appears to experience biofouling while in place with sea grass, sea squirts and other detritus at a rate that requires frequent cleaning.

The current invention solves and resolves a number of these issues by providing an apparatus, ideally entirely of wood (not chemically treated), a much more environmentally friendly construction material that will not diminish the water quality of the water body in which they are maintained, which apparatus has a buoyancy that maintains the apparatus at a proper depth in the water environment, without the need for additional buoyancy elements. The current invention also provides an operable hatch of the top surface of same which is secured with turn buttons to secure the hatch.

The current invention also provides means for preventing the uneven weight distribution of aquatic life within the present invention thereby avoiding the negative level flotation impacts seen in the devices known in the prior art, as described above.

All of the above benefits allow the current invention to overcome the deficits and environmental concerns of the prior art devices and provides an apparatus less prone to biofouling while in use.

### SUMMARY OF THE INVENTION

A device for containing, maintaining and growing aquatic life is provided that includes a frame defining an interior volume which frame can be deployed in a water environment, including means as part of said device to maintain the device in a fixed location. The frame is provided with holes and/or slots that allow water to flow into and out of the interior volume so that the nutrient rich water in the water body in which the device is deployed may provide nutrients to the aquatic life contained within the frame as the water flows thought the device due to the natural movement of the water in the water body.

One object of the subject device is to provide for natural propagation of the aquatic life contained within the device at a predetermined depth relative to the surface of the bottom of the water body.

A further object of the subject device is to provide an environmentally compatible container that does not degrade or contaminate a water body due to extended exposure to sun and water.

A still further object of the present invention is to provide a device with an interior volume that is easy to access for adding or removing aquatic life therefrom.

A still further object of the subject device is to provide for reduced bio-fouling while in use.

In a still further object of the present invention, the size of the slots and/or holes provide therein are selecting to allow proper in/out flow of the nutrient rich water into the interior space of the present invention but not so large that the aquatic life therein is not flushed out of the apparatus.

### DESCRIPTION OF THE DRAWINGS

These and other features, aspects and advantages of the present invention will become better understood with regard to the following description, appended claims and accompanying drawings where:

FIG. 1 is a top perspective view of an aquatic apparatus in accordance with the invention disclosed herein.

FIG. 2 is a side perspective view of an aquatic apparatus in accordance with the invention disclosed herein.

FIG. 3 is a top view of an aquatic apparatus in accordance with the invention disclosed herein, showing the operable door.

FIG. 4 is a bottom view of an aquatic apparatus in accordance with the invention disclosed herein.

FIG. 5 is a top, exploded perspective view of an aquatic apparatus in accordance with the invention disclosed herein, showing the hatch removed and the interior volume therein.

FIG. 6 is a top, exploded perspective view of an aquatic apparatus in accordance with the invention disclosed herein, showing the hatch removed and the interior volume therein which includes mounted baffles.

### DETAILED DESCRIPTION

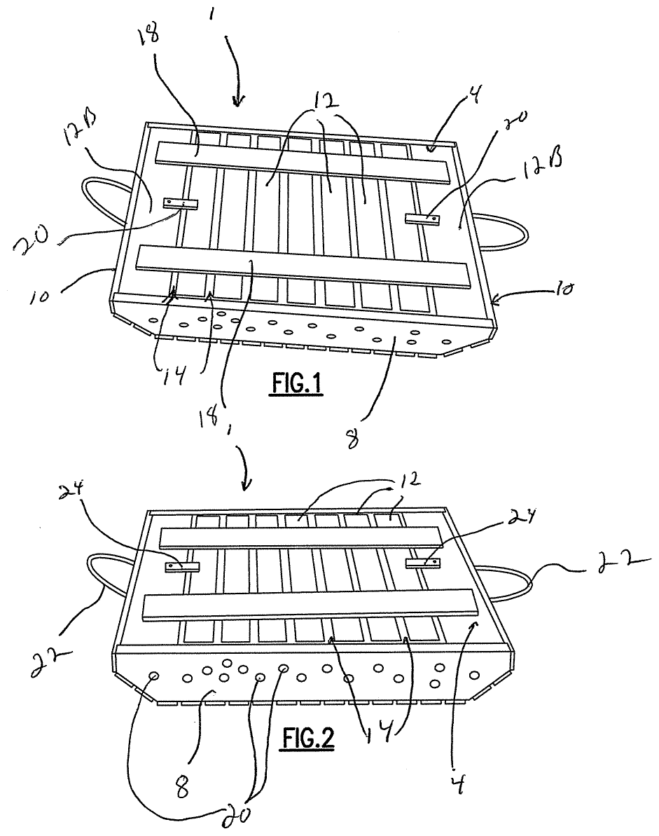

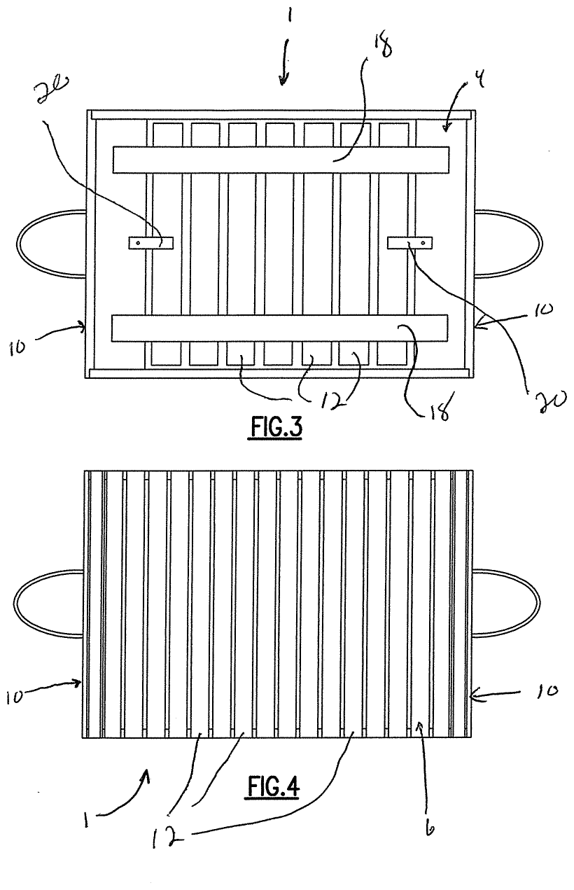

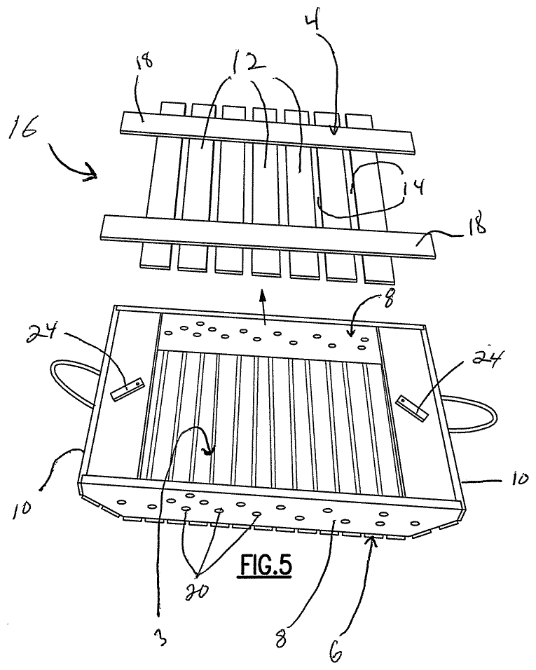

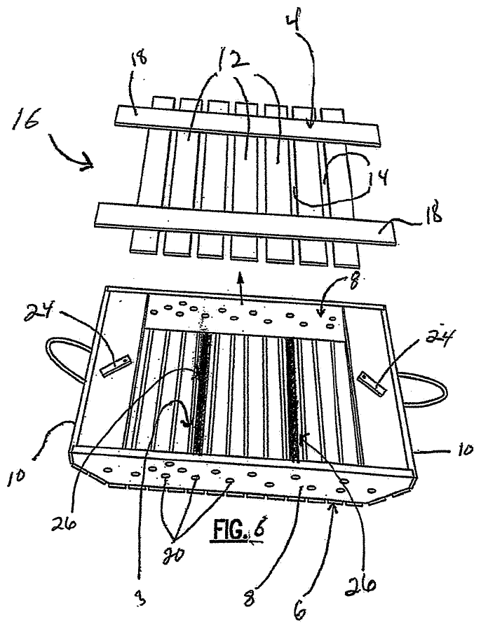

Referring to the drawings, which are for the purpose of illustrating preferred embodiments of the invention only, and not for the purpose of limiting same, FIG. 1-5 show the subject device in its preferred embodiment.

As can be seen the subject apparatus is comprised of a frame 1 that defines an interior volume 3. It is within this interior volume 3 that the aquatic life is maintained and allowed to grow.

The frame 1 having a top surface 4, a bottom surface 6, two side walls 8 and two end walls 10, all permanently assembled together as shown in the drawing in any manner known in the art, including fasteners such as screws or nails or an appropriate form of glue.

The top surface 4 and bottom surface 6 are formed from a series of slats 12 spaced apart from each other a fixed distance thereby forming spaces 14 there between which slat spaces 14 allow the flow of water into and out of the interior volume 3.

The top and bottom surfaces 4 and 6 are, in general, affixed to the top and bottom edges of the side and end walls 8 and 10. However, the top surface 4 includes a removable hatch section 16 which is not permanently fixed to the frame but is held in place by hatch members 18 to which some but not all of the slats 12 that form a part of the top surface 4 are affixed generally perpendicular to the slats 12 which hatch members 18 extend beyond the affixed slats 12 such that when the hatch section 16 is inserted into the top surface 4, the extended portion of the hatch members 18 rest on the permanently affixed top surface slats 12B such that a flush top surface 4 is maintained. The hatch section 16 is removably maintained on the frame 1 by turn buttons 24 which when turned to overlap the hatch section 16 will maintain the hatch section as an integral part of the frame 1 and when turned to not be so overlapped will allow the easy removal of the hatch section 16 such that access to the interior volume 3 may be achieved.

The side sections 8 of the frame 1 most advantageously define a plurality of port holes 20 which port holes 20 communicate to the interior volume 3 of the subject apparatus to allow adequate flow of water into and out of the interior volume 3.

The size of the port holes 20 and the spacing between the top and bottom slats 14 is selected so that water can easily flow through the device, but the aquatic life therein cannot flow out. As the aquatic life grows it can, periodically, be relocated to a device in accordance with the present invention of a larger size.

The frame 1 of the present invention may also be provided with exterior place handles for ease of lifting and moving frame 1. These handles may take any form known in the art but as shown in the Figures most advantageously takes the form of loop handles 22 fixed to opposite sides of the frame.

Finally, the frame 1 of the present invention may include means disposed within the defined interior volume 3 to stabilize the location of the aquatic life contained therein and to prevent side to side movement of the aquatic life while contained in the device of the present invention. This may most advantageously be achieved by the inclusion of a plurality of baffles 26 located within the interior volume 3, the baffles 26 extending from one side wall 8 to the opposite side wall 8 and being mounted to the inside surface of the slats 12 of bottom surface 6 such that water may still flow into and of the frame through the open spaces 14 defined in bottom surface 6.

Although not shown in the drawings, an additional element of the subject apparatus is means for maintaining the apparatus in a fixed location relative to the shoreline or bottom of the water body in which the apparatus is deployed. These means will take the form of some type of anchor system (already known in the art) which while maintaining the apparatus in a fixed location does not interfere with the buoyancy effects of the apparatus itself.

As indicated above, two of the objectives of this current invention is to provide an apparatus that floats in its water environment with a buoyancy that keeps the structure floating with only its upper surface at or just above the water line and to improve access to the inside of the apparatus by providing a hatch on the upper surface. In addition, anti-biofouling properties and durability and resistance to degradation due to sun light and water exposure are necessary components of the subject device.

Typically, woods that achieve this balance are Spruce and Cedar. However, the actual choice for the construction wood will be based on the salinity of the water environment in which the apparatus is deployed as well as other characteristics of the environment such as typical winds, shelter from weather and the like.

The apparatus of the subject invention is most advantageously employed for maintaining and growing oysters but, with adjustments to the slat spacing and hole sizes, may be used for other mollusks and may even be employed to contain bait fish or eels.

It will be clear to one skilled in the art that the summary, detailed description, drawings, and claims provided herein make reference to particular features and methods of employing and deploying the subject apparatus. It is understood that the disclosure of the invention in this specification includes all possible combinations of such particular features. Moreover, many modifications and variations of the present invention are possible in light of the above teachings. Therefore, within the scope of the appended claims, the present invention may be practiced other than as specifically described.

What is claimed is:

1. An apparatus for containing, maintaining and growing aquatic life comprising:
a frame having a top and a bottom surface, two side walls and two end walls and forming a free and open interior volume within said frame of sufficient size to contain said aquatic life;
openings within the top, bottom and side walls of the frame, said openings communicating from the exterior to the interior volume of the apparatus, the openings being provided to allow for the circulation of water through said interior volume; and
a hatch provided in one of the elements forming said frame, such that access to said interior volume is provided.

2. The apparatus of claim 1 wherein the side walls contain holes therethrough communicating from the exterior to the interior of the apparatus.

3. The apparatus of claim 1 further containing means within the interior volume to stabilize the location of the aquatic life containing therein to prevent the shifting of such aquatic life within the apparatus.

4. The apparatus of claim 3 wherein such stabilizing means is comprised of a plurality of baffles affixed to the inside face of the bottom surface slats.

5. A method of containing, maintaining and growing aquatic life comprising the following steps:
placing such aquatic life with the interior volume of the apparatus of claim 1;
replacing said hatch onto said apparatus;
floating said apparatus in a body of water, the top surface of such apparatus floating at or above the surface of such water body; and
securing said apparatus such that its location relative to the shoreline or other point of reference is maintained.
